(19) United States
(12) Patent Application Publication
(10) Pub. No.: US 2026/0025044 A1
(43) Pub. Date: Jan. 22, 2026

(54) SYSTEMS FOR IN-SLOT COOLING WITH END PLATE AND AIR GAP TUBE

(71) Applicant: Ford Global Technologies, LLC, Dearborn, MI (US)

(72) Inventors: Franco Leonardi, Dearborn Heights, MI (US); Michael Degner, Novi, MI (US)

(21) Appl. No.: 18/774,162

(22) Filed: Jul. 16, 2024

(51) Int. Cl. H02K 9/193; H02K 1/18; H02K 3/34

(52) U.S. Cl. CPC H02K 9/193; H02K 1/185; H02K 3/34

(57) ABSTRACT

Systems are provided for an in-slot cooling system of an electric machine for cooling conductors positioned in stator slots of the electric machine. In one example, an in-slot cooling system includes a stator and a rotor, a tube positioned in an air gap between the stator and the rotor, the tube being coupled to a first manifold and a second manifold such that the tube, the first manifold, and the second manifold seal the rotor from coolant fluid. The system further includes an end plate protruding into the stator slots.

### FIELD

The present description relates generally to systems for cooling of electric motors. Specifically, a cooling system may include a sealing system including an end plate and an air gap tube.

### BACKGROUND/SUMMARY

A cooling system may be demanded to reduce heat and allow for continuous power output of an electric machine (e.g., traction motor of a vehicle) comprising a rotor and a stator. Conventional systems may cool stator end windings and prevent coolant fluid from flowing into slots of the stator where the greatest portion of conductors (e.g., copper wires) are located. It may be advantageous to allow flow of coolant in close proximity to conductors positioned in the slots to increase cooling effectiveness (e.g., reduce temperature of the conductors, increase rate of cooling). However, coolant leaking into an air gap between the stator and rotor may increase drag torque of the electric machine, thereby lowering efficiency.

In one example, the issues described above may be at least partially addressed by an in-slot cooling system, including a tube positioned in an air gap between a stator and a rotor. The in-slot cooling system may further include a first manifold that encloses a first portion of a plurality of conductor bundles at a first end of the stator and a second manifold at a second end of the stator, the first manifold and the second manifold being coupled to the tube. Additionally, an end plate may be positioned at one end of the stator and protrude into one or more of a plurality of stator slots extending through the stator. In this way, coolant fluid may enter the stator slots to cool the conductor bundles more than systems wherein coolant does not contact portions of the conductor bundles in the stator slots. Further, leaking of the coolant fluid into the air gap may be prevented, thereby reducing drag losses on rotation of the rotor.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 schematically shows an example vehicle powertrain that may comprise a cooling system in accordance with the present disclosure.

FIG. 2 schematically shows an air gap tube of the sealing system.

FIG. 3 shows a first view of the air gap tube coupled to a first manifold.

FIG. 4 shows a second view of the air gap tube coupled to the first manifold and a stator.

FIG. 5 shows a third view of the air gap tube coupled to the first manifold, the stator, and a second manifold.

FIG. 6 shows a first view of an end plate of the sealing system.

FIG. 7 shows a second enlarged view of the end plate.

FIG. 8 shows a third enlarged view of the end plate.

FIG. 9 shows a cross section view of the end plate and a plurality of conductors.

FIG. 10 shows the air gap tube coupled to the end plate.

FIG. 11 shows a perspective view of the end plate and the conductors.

FIG. 12 shows the end plate and the conductors with the conductors covered by insulating tubes.

FIGS. 13A and 13B show insulating tubes covering the conductors.

FIG. 14 schematically shows a cross section of an electric machine with the air gap tube.

### DETAILED DESCRIPTION

The following description relates to systems for in-slot cooling of electric machines comprising a rotor and a stator. Traditional cooling systems may include coolant fluid contained in reservoirs adjacent to the stator wherein ends of conductors are located. In-slot cooling may additionally include coolant fluid entering stator slots in a stator of the electric machine to surround a greater portion of the conductors, thereby increasing heat transfer area and consequently increasing a cooling effect of the coolant fluid.

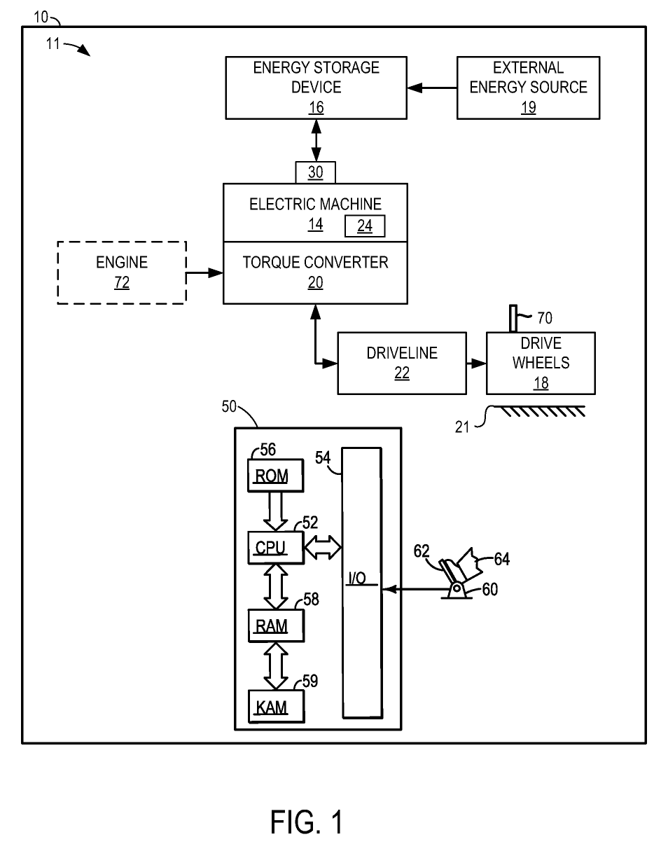

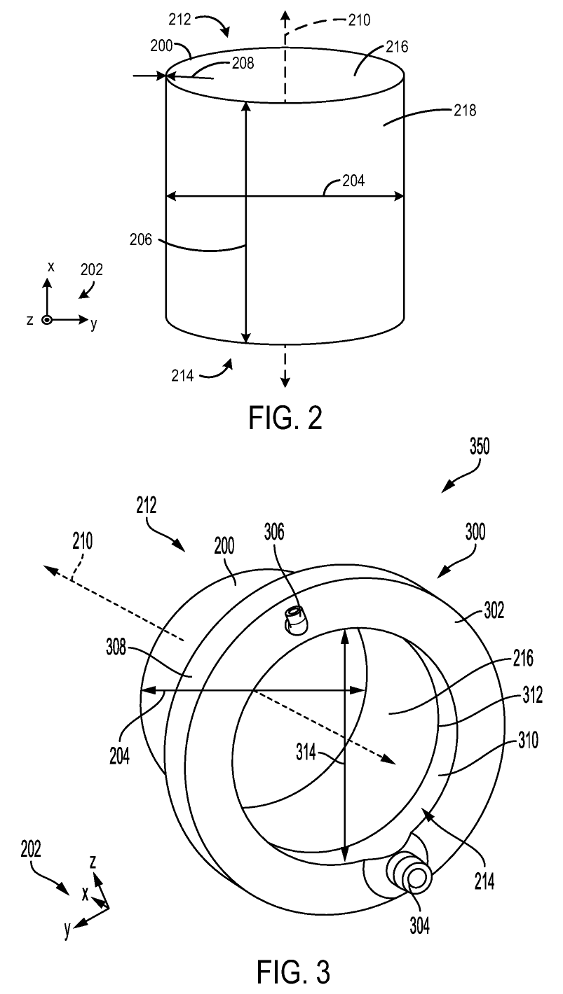

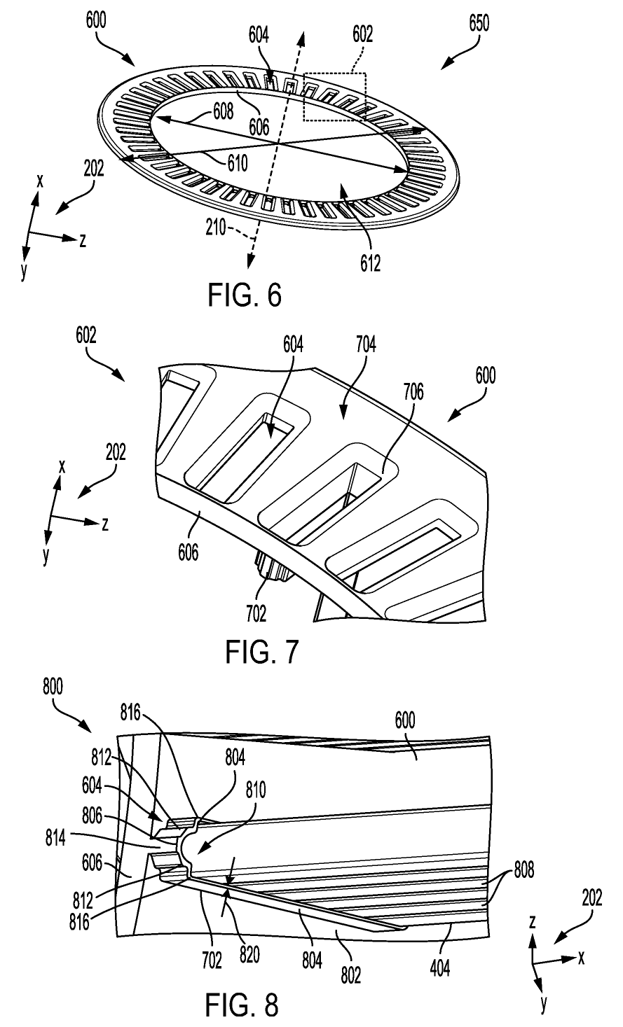

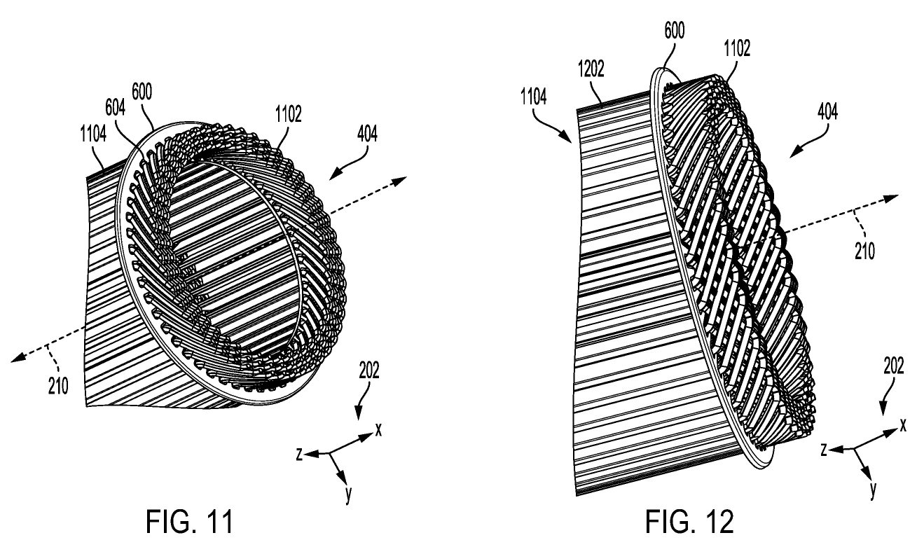

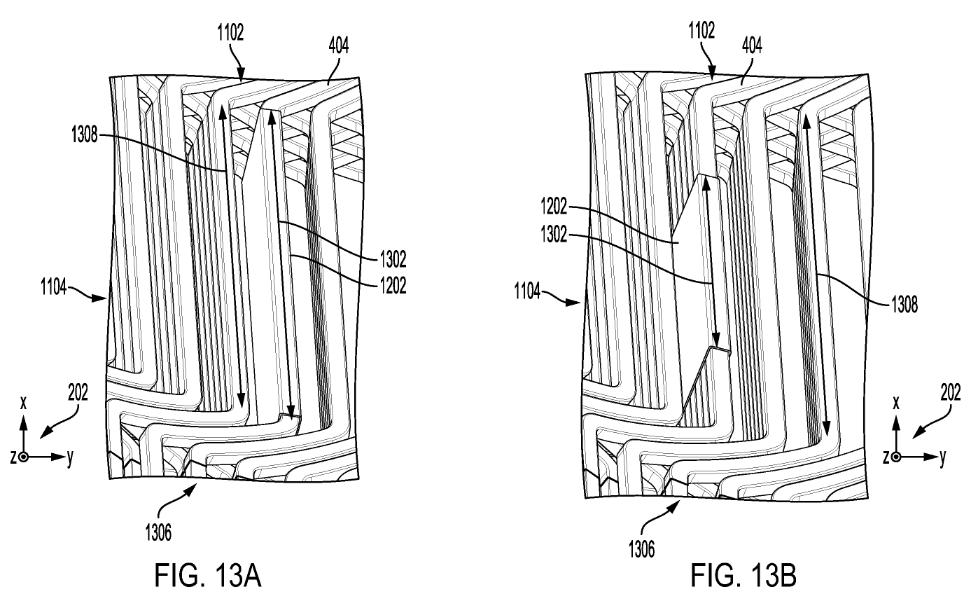

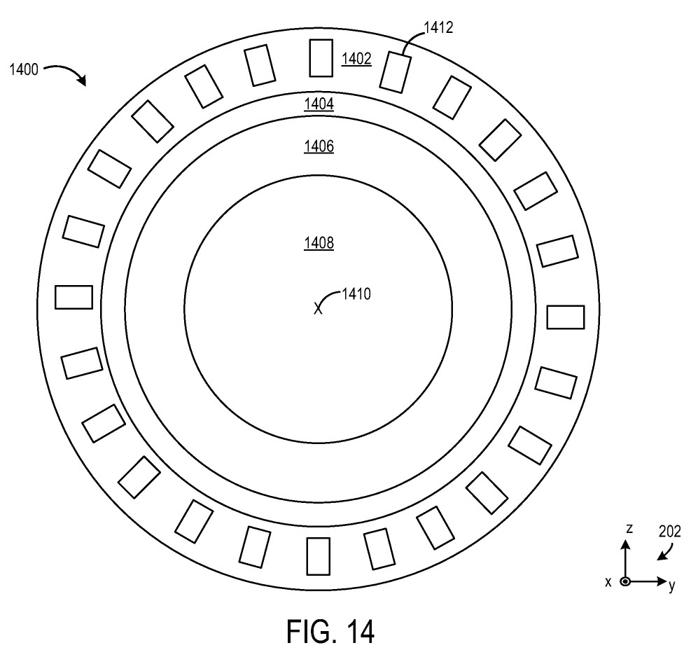

An electric machine with the in-slot cooling system of the present disclosure may be incorporated into a vehicle, such as the vehicle shown schematically in FIG. 1. The in-slot cooling system may comprise an air gap tube, such as the example provided in FIG. 2, positioned within a space between the rotor and the stator to prevent fluid from leaking from the stator and causing drag losses on rotation of the rotor. Specifically, the air gap tube may circumferentially surround the rotor and the stator may circumferentially surround the air gap tube. The cooling system may further comprise a first manifold and a second manifold positioned on either axial end of the air gap tube as shown in FIGS. 3-5, wherein the first manifold and the second manifold may enclose ends of conductors extending through stator slots in the stator. One or two end plates such as the example depicted in FIG. 6 may be bonded to the air gap tube as shown in FIG. 10, and adapted to align with the stator (e.g., in a straight line) such that the conductors extend through the stator slots and the one or two end plates. The end plate may comprise protrusions as shown in FIGS. 7-9 which may align slots of the end plate with slots of the stator, restrict the conductors from moving, and allow fluid to surround the conductors while flowing through the stator slots. The conductors may be arranged in conductor bundles, wherein one conductor bundle extends through each stator slot and each conductor bundle comprises a plurality of conductors (e.g., conductive wires), as shown in FIG. 11. Further, the conductor bundles may each be wrapped in shrink wrap style insulator tubes as shown in FIG. 12, wherein the insulator tubes may be approximately the same length as the of the stator slots as shown in FIG. 13A, or shorter than the stator slots as shown in FIG. 13B. In this way, the in-slot cooling system disclosed herein may increase a rate and extent of cooling (e.g., thermal energy removal) of the conductors extending through the stator and prevent leakage of coolant fluid into the air gap between the rotor and the stator. FIG. 14 shows a schematic of a cross section of an electric machine with the air gap tube.

Turning to FIG. 1, an example of a vehicle 10 with a propulsion system 11 (e.g., electric propulsion system) is shown. Propulsion system 11 includes an electric machine 14 (e.g., energy conversion device). The electric machine 14 may be incorporated into an axle of the vehicle 10 and may comprise an in-slot cooling system 24 according to the present disclosure. The electric machine 14 is controlled via controller 50. In some examples, the vehicle propulsion system 11 may further include an engine 72, where the engine 72 may be an internal combustion engine.

The electric machine 14 is further shown coupled to an energy storage device 16, which may include a battery (e.g., traction battery), a capacitor, inductor, or other electric energy storage device. The electric machine 14 can be operated to convert mechanical energy received from the vehicle driveline into a form of energy suitable for storage by the energy storage device (e.g., provide a generator operation). The electric machine 14 can also be operated to supply an output (power, work, torque, speed, etc.,) to drive wheels 18 (e.g., provide a motor operation). It should be appreciated that the electric machine 14 may, in some embodiments, function only as a motor, only as a generator, or both a motor and generator, among various other components used for providing the appropriate conversion of energy between the energy storage device and the vehicle drive wheels. For instance, the electric machine 14 may include a motor, a generator, integrated starter generator, starter alternator, among others and combinations thereof. The electric machine 14 may also include or be coupled to an inverter 30. The inverter 30 may be configured to condition electrical energy in and out of the energy storage device (e.g., high voltage battery). However, in other examples, the vehicle may not include an inverter.

The energy storage device 16 may be selectively coupled to an external energy source 19. For example, the energy storage device 16 device may be periodically coupled to a charging station (e.g., commercial or residential charging station), portable energy storage device, etc., to allow the energy storage device 16 to be recharged.

The electric machine 14 is coupled to a torque converter 20. The torque converter 20 is a fluid coupling designed to transfer rotational input from the electric machine 14 to a driveline 22. The driveline 22 includes a transmission with gearing and other suitable mechanical components (e.g., a gearbox, axles, transfer cases, etc.) designed to transfer rotational motion to the drive wheels 18. The drive wheels 18 may be supported by and drive vehicle 10 across a surface 21.

The torque converter 20 and the electric machine 14 are depicted as an interconnected unit. However, in other examples, the torque converter 20 and the electric machine 14 may include discrete enclosures.

The electric machine 14 may include one or more clutches designed to selectively rotationally couple the rotor of the electric machine 14 to the torque converter 20. For instance, the clutch or clutches may each include plates, splines, and/or other suitable mechanical components allowing the machine to be rotationally connected as well as disconnected from the engine 72 or the torque converter 20.

The depicted connections between electric machine 14, driveline 22, and drive wheel 18 indicate transmission of mechanical energy from one component to another, whereas the connections between the electric machine 14 and the energy storage device 16 may indicate transmission of a variety of energy forms such as electrical, mechanical, etc. For example, torque may be transmitted from the electric machine 14 to drive the vehicle drive wheels 18 via the driveline 22. As described above, the electric machine 14 may be configured to operate in a generator mode and/or a motor mode. In a generator mode, propulsion system 11 receives some or all of the output from electric machine 14, which reduces the amount of drive output delivered to the drive wheel 18, or the amount of reverse torque to the drive wheel 18. Operations of the vehicle 10 that use the generator mode may be employed, for example, to achieve energy efficiency gains through regenerative torque capture, increased engine efficiency (if included), etc. Further, the output received by the electric machine 14 may be used to charge the energy storage device 16. In motor mode, the electric machine 14 may supply mechanical output to the driveline 22, for example by using electrical energy stored in an electric battery. Additionally, the engine 72 may supply rotational output to the driveline 22, in some instances.

The electric machine 14 may also be used to deliver electrical energy to external, auxiliary devices during power take-off. The electric machine 14 may run during power take-off when the drive wheels 18 are not in motion, allowing power output from the electric machine 14 to be directed at least partially towards operating the auxiliary devices.

In examples where the vehicle 10 comprises engine 72, engine 72 may have an output coupled to the torque converter 20 and may be incorporated into the axle of the vehicle. The engine 72 may be controlled via a controller 50. Both the engine 72 and electric machine 14 may act as movers to drive the vehicle 10. For example, the vehicle 10 may be a hybrid vehicle. In examples including engine 72, rotational energy in the form of torque from the engine 72 or other rotational and mechanical energy from components may be converted into electrical energy by the electric machine 14. The output of the electric machine 14 to the torque converter 20 may act as an input for the transfer and transformation of torque into electrical energy during hybrid operations.

The controller 50 receives signals from the various sensors of FIG. 1 and employs the various actuators of FIG. 1 to adjust vehicle operation based on the received signals and instructions stored in non-transitory memory of the controller 50. Specifically, controller 50 is shown in FIG. 1 as a conventional microcomputer including: microprocessor unit 52, input/output ports 54, read-only memory 56, random access memory 58, keep alive memory 59, and a conventional data bus. Controller 50 is configured to receive various signals from sensors coupled to the propulsion system 11 and send command signals to actuators in components in the vehicle, such as the electric machine 14. Additionally, the controller 50 is also configured to receive pedal position (PP) of a pedal 62 actuated by a user 64. The PP may be estimated by and received from a pedal position sensor 60 coupled to the pedal 62. Therefore, in one example, the controller 50 may receive a pedal position signal and adjust actuators in the electric machine 14 based the pedal position signal to vary the rotational output of the electric machine 14. The sensors communicating with the controller 50 may include an electric machine sensor (e.g., resolver or Hall effect sensor for sensing a rotor position of the electric machine), and wheel speed sensor 70, accelerometer, etc. The controller 50 may send commands to a pump (not shown) to control pressure and flow rate of coolant fluid flowing through the in-slot cooling system 24 of the electric machine 14.

The electric machine 14 may comprise a rotor and a stator, wherein the stator circumferentially surrounds the rotor with a gap maintained therebetween. Conductors (e.g., windings, copper wires) adapted to generate a magnetic field in order to rotate the rotor may extend through the stator. The conductors may be susceptible to excessive heat due at least in part to high electrical power. Thus, the in-slot cooling system 24 may be employed to reduce a temperature of the conductors. For example, the in-slot cooling system 24 in accordance with the present disclosure may include coolant fluid flowing within slots (e.g., through holes) in the stator wherein the conductors are positioned. Thus, coolant fluid may surround a full length of the conductors, thereby increasing cooling effects of the coolant fluid compared to systems wherein coolant contacts only the ends of the conductors not within the stator. Further, the in-slot cooling system disclosed herein may include an air gap tube, such as the air gap tube 200 of FIGS. 2-5, and 10, to prevent leaking of coolant fluid into the gap between the rotor and the stator, thereby preventing drag losses and other power losses due to the rotor rotating in fluid.

For example, turning to FIG. 14, a cross section of an electric machine 1400 (e.g., the electric machine 14 of FIG. 1) with the in-slot cooling system disclosed herein is shown schematically. Reference axes 202, including an x-axis, a y-axis, and a z-axis, are provided in FIGS. 2-14, wherein the x-axis is an axial direction parallel with an axis of rotation of the rotor, and the y-axis and the z-axis are radial directions.

A rotor 1408 may be positioned with a stator 1402 with an air gap 1406 therebetween. An air gap tube 1404 may be positioned within the air gap 1406. The rotor 1408, the stator 1402, and the air gap tube 1404 may be coaxial (e.g., centered about the axis 1410) and sized such that the air gap tube 1404 is closer to the stator 1402 than the rotor 1408. The air gap tube 1404 may be closer to the stator 1402 than the rotor 1408. As shown in FIG. 14, the air gap tube 1404 may be in face sharing contact with the stator 1402. However, the air gap tube 1404 may also be spaced away from the stator 1402 in other examples. The rotor 1408, the air gap tube 1404, and the stator 1402 may be centered about an axis 1410, wherein the axis 1410 is an axis of rotation of the rotor 1408 parallel with the x-axis. The stator 1402 comprises a plurality of radially arranged stator slots 1412 through which conductors (e.g., windings) may extend. The in-slot cooling system of the present disclosure may allow for coolant fluid to flow through the stator slots 1412 to cool the conductors without leaking towards the rotor 1408. In this way, drag losses on the rotor 1408 may be prevented while a temperature of the conductors may be reduced.

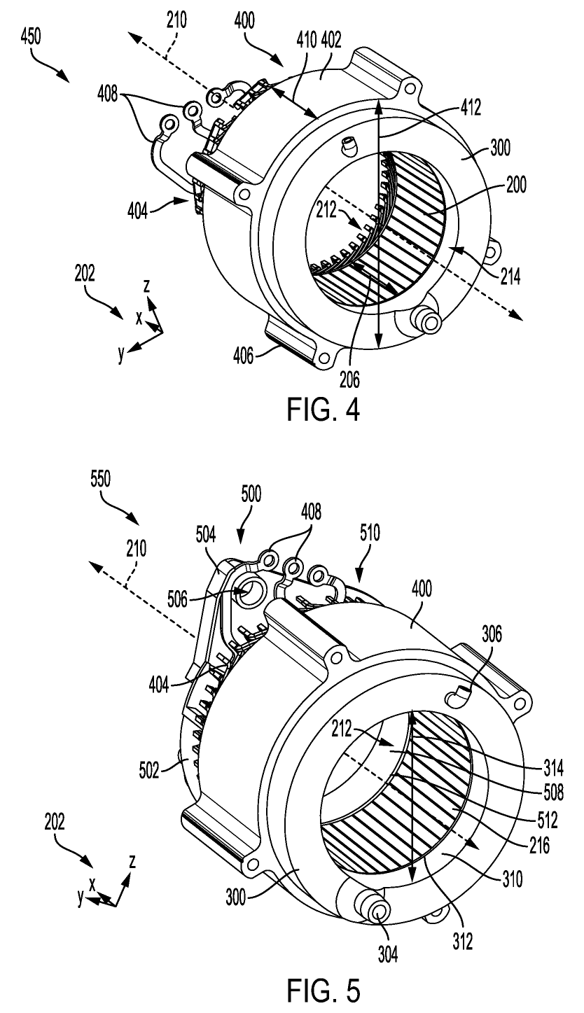

Turning to FIG. 2, an air gap tube 200 (e.g., an embodiment of the air gap tube 1404) of an in-slot cooling system of the present disclosure is shown. The air gap tube 200 is also referred to herein as tube 200. The tube 200 may be adapted to be included in an electric machine comprising a stator (e.g., the stator 400 of FIG. 4) and a rotor, such as the electric machine 14 of FIG. 1 or the electric machine 1400 of FIG. 14. As described above, the tube 200 may be interposed within an air gap between the stator and the rotor, wherein the rotor is circumferentially surrounded by the stator. In this way, the tube 200 may separate a wet area (e.g., stator) of the electric machine from a dry area (e.g., rotor) of the electric machine.

The tube 200 may be of hollow cylindrical shape centered about an axis 210 (e.g., the axis 1410) parallel with the x-axis. The axis 210 may additionally be an axis of rotation for the rotor (not shown). An outer surface 218 of the tube 200 may face radially outwards away from the axis 210 and an inner surface 216 of the tube 200 may face radially inwards towards the axis 210. The tube 200 may have a diameter 204 perpendicular to the axis 210, a length 206 parallel with the axis 210, and a thickness 208. The diameter 204 is an outer diameter of the tube 200. The tube 200 may have a circular opening at a first end 212, and a circular opening at a second end 214, wherein the second end 214 is opposite the first end 212 along the axis 210. The diameter 204 may be sized to fit within a bore in the stator as described with regards to FIG. 14. The thickness 208 may be, for example, approximately 0.2 mm. However, other dimensions are possible without departing from the scope of the present disclosure. The tube 200 may be constructed from a non-conductive material, such as epoxy, plastic, or the like.

Turning to FIG. 3, a view 350 of the air gap tube 200 connected to a first manifold 300 is shown. Specifically, the first manifold 300 may be positioned at the second end 214. The first manifold may be adapted to encompass a portion of conductors (e.g., conductor bundles 404 of FIGS. 4, 5, and 11-13B) extending beyond the second end 214.

The first manifold 300 may comprise a base 302 of an annular cylindrical shape with one or more inlets extending therefrom through which fluid may pass through the first manifold 300. The one or more inlets may extend axially, radially, or at any other angle from the manifold 300. The fluid (e.g., coolant) may be pumped into the one or more inlets at a flow rate and pressure controlled by a controller (e.g., the controller 50 of FIG. 1). For example, the one or more inlets may include a first inlet 304. The first manifold 300 may include other features, including ports such as port 306 for temperature sensors and the like. Any placement, size, and shape of the one or more inlets and ports is possible without departing from the scope of the present disclosure. The first manifold 300 may have an outer surface 308 facing outwards, away from the axis 210, and an inner surface 310 facing inwards, towards the axis 210. The inner surface 310 may have a diameter 314 approximately the same as the diameter 204 such that the inner surface 216 is flush with the inner surface 216. In other examples, the diameter 314 may be greater than the diameter 204 and the tube 200 may extend axially further than shown such that the outer surface 218 is in face sharing contact with the inner surface 310. Further, the tube 200 may be coupled to an outer edge 320 of the inner surface 310. In this way, the manifold 300 may circumferentially surround the tube 200. A seal may be formed between the tube 200 and the first manifold 300 such that fluid (e.g., coolant) may not leak through an interface 312 between the first manifold 300 and the tube 200. For example, an adhesive (e.g., epoxy) may be applied between the tube 200 and the first manifold 300 such that fluid may not leak through the adhesive. In other examples, the seal may be formed by other means, such as a gasket. Alternatively, the tube 200 and the first manifold 300 may be integrally formed as a single component. The first manifold 300 may be secured to the tube 200 before or after installation onto a stator.

Turning to FIG. 4, a view 450 of the tube 200 and the first manifold 300 installed onto a stator 400 is shown. The stator 400 may comprise an annular surface 402 circumferentially surrounding the tube 200 and a plurality of mounting extensions 406 protruding outwards from the annular surface 402. The mounting extensions 406 may be used to secure, such as via fastening, the stator 400 to external components, such as a housing encompassing the stator 400. The stator 400 may further include a plurality of winding terminals 408 adapted to couple with a terminal block or an inverter such as the inverter 30 of FIG. 1. The length 206 may be approximately the same as an axial length 410 of the stator. In other examples, the length 206 may be greater than the length 410 such that the tube 200 is longer than the stator 400. Thus, in some examples, the tube 200 extends axially beyond the stator 400 on one end or both ends. A plurality of conductor bundles 404 may extend through slots (e.g., the stator slots 1412 of FIG. 14) within the annular surface 402 parallel with the axis 210 from within the first manifold 300 to beyond the first end 212. Further details as to the conductor bundles 404 are described below in regards to FIGS. 11-13B. The stator 400 may be in face sharing contact with the first manifold 300. The stator may have a greater inner diameter than the diameter 204 (shown in FIGS. 2 and 3) such that the stator circumferentially surrounds the tube 200. The stator 400 may have a greater outer diameter 412 than the first manifold 300 such that the stator 400 extends radially further than the first manifold 300.

Turning to FIG. 5, a view 550 of a second manifold 500 connected to the tube 200 at the first end 212 is shown. The second manifold 500 may be attached to the tube 200 after installation onto the stator 400. The second manifold 500 may be adapted to at least partially enclose ends of the conductor bundles 404 extending beyond the first end 212. Thus, a first portion of the conductor bundles 404 may be positioned within the first manifold 300, a second portion of the conductor bundles 404 may be positioned within stator slots of the stator 400, and a third portion of the conductor bundles 404 may be positioned within the second manifold 500, wherein the first portion, the second portion, and the third portion are regions of the conductor bundles 404 in that order along the x-axis. The second manifold 500 may be fluidly coupled to the first manifold 300 via the stator slots of the stator 400 such that coolant fluid may contact (e.g., flow around) the conductor bundles 404. In this way, the first portion, the second portion, and the third portion of the conductor bundles 404 may be cooled by the coolant fluid. In other words, an entire length of the conductor bundles 404 may be cooled by the coolant fluid, rather than just the ends (e.g., first portion and third portion) as in other cooling systems.

For example, the second manifold 500 may include a hollow annular cylinder 502 with a triangular extension 504 extending radially outwards to accommodate the plurality of protrusions 408. The triangular extension 504 may include an outlet 506 through which fluid may flow out of the second manifold 500. An inner surface 508 of the second manifold 500 may face radially inwards towards the axis 210 with a dimeter approximately the same as the diameter 314 such that the inner surface 508 is flush with the inner surface 216 and the inner surface 310. In other examples, the diameter 204 may be smaller than the diameter 314 and the tube 200 may extend axially further than shown in FIG. 5 such that the outer surface 218 is in face sharing contact (rather than flush) with the inner surface 310 and the inner surface 508. Further, the tube 200 may be coupled to the outer edge 320 of the inner surface 310 and an outer edge 520 of the inner surface 508. In this way, the first manifold 300 and the second manifold 500 may circumferentially surround at least part the tube 200. Similar to the first manifold 300, the second manifold 500 may be sealably coupled to the tube 200 (e.g., via adhesive) to prevent fluid from leaking through an interface 512 therebetween towards the axis 210. Thus, the tube 200 may be sealably coupled to both the first manifold 300 and the second manifold 500 such that fluid does not flow through interfaces therebetween (e.g., the interface 312 and the interface 512) towards the rotor.

The second manifold 500 may be a full or partial manifold. For example, the second manifold 500 is shown as a partial manifold with an opening 510 to the exterior of the hollow annular cylinder. However, in other examples, the second manifold 500 may fully enclose the ends of the conductor bundles 404, similar to the first manifold 300. The second manifold 500 may be shaped as a full or partial manifold according to a desired pressure and flow pattern of the coolant.

Turning to FIG. 6, a view 650 an example of an end plate 600 is shown. An in-slot cooling system, such as the cooling system 24 of FIG. 1, may include two end plates, such as the end plate 600, positioned at each axial end of a stator, such as the stator 400 of FIGS. 4 and 5. In other examples, the in-slot cooling system may include a single end plate, such as the end plate 600, on one end of the stator. The end plate 600 may be in face sharing contact with the stator. Further, the end plate 600 may have an outer diameter 610 less than an outer diameter of the stator (e.g., outer diameter 412 of the stator 400 shown in FIG. 4). Further, the outer diameter 610 may be small enough that the end plate 600 is enclosed within a manifold (e.g., the manifold 300 or the manifold 500 of FIG. 5).

The end plate 600 may be an annular plate with a plurality of end plate slots 604 (e.g., through holes) arranged radially about the annular plate. More specifically, the end plate slots 604 may be arranged around a hole 612, where the hole 612 may be circular in shape. An inner diameter 608 of the end plate 600 (e.g., diameter of the hole 612) may be approximately the same as a diameter of an air gap tube (e.g., the diameter 204 of the air gap tube 200), such that the end plate 600 may fit around and be in face sharing contact with the air gap tube as shown in FIG. 10. Additionally, the inner diameter 608 may be less than or approximately equal to a bore diameter of a bore in a stator (e.g., the stator 400 of FIGS. 4 and 5). An outer diameter 610 of the end plate 600 may be approximately the same as an outer diameter of the stator (e.g., the outer diameter 412 of FIG. 4). The end plate slots 604 may be radially arranged and equidistantly spaced in at least some examples. The end plate slots 604 may be rectangular in shape with longer side lengths aligned with radial directions (e.g., perpendicular to the x-axis) from the center of the end plate 600 and perpendicular to an inner surface 606 of the end plate 600 facing towards the axis 210. The end plate slots 604 may be shaped similarly to stator slots (e.g., the stator slots 1412 of FIG. 14) such that the end plate slots 604 align with the stator slots, forming a continuous path through the end plate slots 604 and the stator slots. For example, when aligned, areas of the end plate slots 604 overlap the stator slots. Thus, end plate dimensions (e.g., inner and outer diameter) and geometry (e.g., slot size, number, and shape) may be different than shown in FIG. 6 according to the stator. For example, end plate slots 604 may be shaped according to the stator slots.

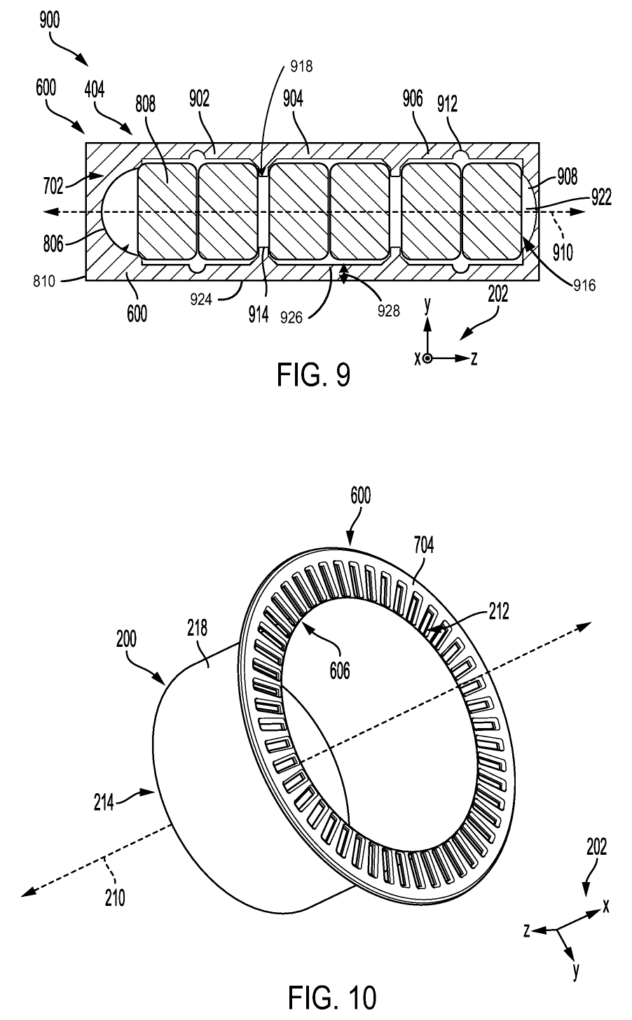

A portion 602 of FIG. 6 is shown enlarged in FIG. 7. As shown in FIG. 7, the end plate 600 includes one or more protrusions 702 extending from the slots perpendicularly to a first flat surface 704. The first flat surface 704 may be opposite the protrusions 702 across the annular plate. At least a portion of the first flat surface 704 may be in face sharing contact with a manifold, such as the first manifold 300 of FIGS. 3-5 or the second manifold 500 of FIG. 5, when assembled onto a stator and in-slot cooling system of the present disclosure. Further, the end plate 600 may couple to the air gap tube 200 of FIGS. 2-5 as shown and described further in FIG. 9.

The protrusions 702 may be adapted to fit within corresponding stator slots in the stator (e.g., the stator slots 1412 of FIG. 14). In this way, the end plate 600 may align with the stator, such that the stator slots and the end plate slots 604 provide a continuous path for conductors (e.g., windings), such as the conductor bundles 404 of FIGS. 4 and 5, to extend through. For example, the end plate 600 may be coaxial with the stator about the axis 210. Further, areas of the end plate slots 604 may overlap areas of corresponding stator slots. In some examples, there may be a protrusion 702 extending from each of the end plate slots 604. In other examples, not all end plate slots 604 may have a protrusion 702 extending therefrom. For example, alternating end plate slots 604 may have protrusions 702. Thus, the end plate 600 may include one or more protrusions 702 extending axially from the end plate slots 604 such that the protrusions 702 are aligned with and protruding into corresponding stator slots.

The end plate slots 604 may include chamfered edges 706 about perimeters defining the end plate slots 604. The chamfered edges 706 may extend between the surface 704 and the protrusion 702. The chamfered edges 706 may be angled edges in some examples, or curved edges in other examples. Thus, the chamfered edges 706 may also be referred to as fillets. Due to the chamfered edges 706, fluid (e.g., coolant) may flow from an area adjacent to the surface 704 (e.g., a reservoir enclosed by the manifold 300 or the manifold 500 of FIG. 5) into the end plate slots 604 with a smooth flow path into the stator slots. In this way, the fluid may be directed by the protrusions 702 to flow around the conductor bundles 404 as described further with regards to FIGS. 8 and 9 below. Further, the chamfered edges 706 may prevent (e.g., reduce) degradation of the end plate 600 due to reduced stress imposed by fluid flow compared to sharp edges (e.g., corners without chamfer, fillet, or the like).

Turning to FIG. 8, a second enlarged view 800 of the end plate 600 is shown with one of the conductor bundles 404 extending through one of the end plate slots 604. A first example of the protrusion 702 is shown. The conductor bundles 404 may each comprise a plurality of conductors 808 (e.g., copper wires). A second flat surface 802 of the end plate 600 may be parallel and opposite from the first flat surface 704 of FIG. 7. The protrusion 702 may extend perpendicularly from the second flat surface 802. The second flat surface 802 may be in face sharing contact with a stator such as the stator 400 when assembled, as shown in FIG. 5. The protrusion 702 may be inserted into a stator slot of the stator to align therewith. As such, the protrusion 702 may take a variety of shapes according to the stator geometry.

The protrusion 702 may include a rounded end 806. The conductor bundle 404 may not be in face sharing contact with the rounded end 806. The rounded end 806 may create a first gap 810 between the conductor bundle 404 and the protrusion 702, thereby allowing fluid (e.g., coolant) to flow around the conductor bundle 404, through the end plate slot 604 and the protrusion 702 via the first gap 810.

The protrusion 702 is shown in FIG. 8 with a straight edge 804 on each of the longer sides of the protrusion 702, where the straight edge 804 may be in face sharing contact with the conductor bundle 404. A thickness 820 of the protrusion 702 may be approximately the same along the entire perimeter of the protrusion 702 such that an outer edge 812 corresponding to the rounded end 806 may have a waved shape connecting a flat end 814 to a corner 816 where the outer edge 812 meets each of the straight edges 804. The corners 816 may fix the conductor bundle 404 in place. Further, the flat end 814 may be continuous with the inner surface 606. However, the protrusion 702 may take other shapes, for example to further resist movement of the conductors 808 and allow flow of fluid (e.g., coolant) around the conductors 808.

Turning to FIG. 9, a second example of the protrusion 702 is shown in a view 900 with one of the conductor bundles 404 extending through the protrusion 702 parallel with the x-axis. The view 900 may be a view looking down the x-axis at the second flat surface 802 of FIG. 8. The second example of the protrusion 702 shown in FIG. 9 may be different (e.g., in shape) from the first example of the protrusion 702 provided in FIG. 8. For example, as shown in FIG. 9, an outer surface 924 of the protrusion 702 and an inner surface 926 of the protrusion 702 may be shaped such that a thickness 928 (e.g., distance between the inner surface 926 and the outer surface 924) may be irregular, whereas the thickness 820 in FIG. 8 may be approximately the same along the whole protrusion 702. Further, the outer surface 924 may be rectangular in the example shown in FIG. 9, rather than a combination of rectangular and waved in the example shown in FIG. 8. For example, the outer surface 924 may be shaped according to a shape of corresponding stator slot in which the protrusion 702 is adapted to extend.

As described above, the protrusions 702 may be adapted to restrict movement of the plurality of conductor bundles 404 and allow flow of coolant fluid therearound. For example, as shown in FIG. 9, the protrusions 702 may include a combination of rectangular sections and rounded sections (e.g., of the inner surface 926) depending on a desired flow of coolant fluid around the conductor bundles 404. For example, each of the protrusions 702 may include a first rectangular section 902, a second rectangular section 904, and a third rectangular section 906 with the first rounded end 806 at a first end of the protrusion 702 and a second rounded end 908 at a second end opposite the first end. Similar to the first rounded end 806, the second rounded end 908 may be spaced away from the conductor bundle 404 such that fluid may flow through the protrusion 702 via a second gap 916 formed between the second rounded end 908 and the conductor bundle 404. In this way, fluid may flow around sides of the conductor bundle 404 via the first gap 810 and the second gap 916 such that a heat transfer area where coolant contacts the conductors 808 includes a first side 920 and a second side 922 adjacent to the first gap 810 and the second gap 916, respectively.

A plurality of spacers 914 may divide the rectangular sections. The spacers 914 may fix the conductors 808 of the conductor bundles 404 in place. In this way, fluid may flow approximately evenly around the conductor bundle 404. The spacers 914 may extend inwards (e.g., towards axis 910) from the protrusion 702 perimeter. The spacers 914 may be chamfered, filleted, beveled or the like such that the conductors 808 are at least partially spaced from perimeters defining the rectangular sections (e.g., the first rectangular section 902, the second rectangular section 904, and the third rectangular section 906). Further, the spacers 914 may create spaces 918 between conductors 808 of the conductor bundle 404. In this way, the heat transfer area may be increased to include surfaces of the conductors 808 defining the spaces 918, thereby further cooling the conductors 808.

There may be one or more conductors 808 positioned in each rectangular section. FIG. 9 shows two conductors 808 in each of the first rectangular section 902, the second rectangular section 904, and the third rectangular section 906, however, other arrangements of conductors 808 are possible without departing from the scope of the present disclosure. The protrusions 702 may include rounded sections 912 extending from one or more of the rectangular sections. The rounded sections 912 may be spaced away from the conductors 808 such that fluid may flow around the conductors 808 via the rounded sections 912. In at least some examples, the protrusions 702 may be symmetrical across the axis 910. In this way, fluid may flow approximately evenly about the perimeter of the conductor bundle 404 such that the heat transfer area may be further increased.

Thus, coolant fluid may surround the conductors 808 due to the shape of the protrusions 702. The protrusions 702 may direct fluid flow around the conductors 808 such that the heat transfer area is increased, thereby increasing heat transfer from the conductors 808 to the fluid. The protrusions 702 may take one of the two exemplary shapes provided in FIGS. 8 and 9, or other shapes adapted to direct fluid flow and fix the conductors 808 in place without departing from the scope of the present disclosure.

Turning to FIG. 10, the end plate 600 is shown attached (e.g., bonded) to the air gap tube 200. The inner surface 606 may be in face sharing contact with the outer surface 218. Further, the first flat surface 704 may be flush with the first end 212. In other examples, additionally or alternatively, the end plate 600 may be positioned at the second end 214. In examples wherein two end plates 600 are included with one at the first end 212 and the other at the second end 214, the protrusions 702 of FIGS. 7-9 of the end plates 600 may extend axially towards each other. In examples where the tube 200 is longer than the stator (e.g., stator 400 of FIGS. 4 and 5), the end plate 600 may be bonded to the air gap tube 200 near an end (e.g., first end 212 or second end 214) such that the first flat surface 704 is spaced away from the end. Thus, the tube 200 may extend axially beyond the end plate 600 in such examples. By attaching the end plate 600 to the tube 200, the tube 200 may be fixed in place relative to a stator (e.g., stator 400 of FIGS. 4 and 5) via the protrusions 702 extending into the stator. However, in some examples, end plates 600 may not be included in an in-slot cooling system in accordance with the present disclosure. For example, the tube 200 may be fixed in place instead by adhesive bond or integral formation with manifolds (e.g., first manifold 300 or second manifold 500 of FIG. 5) and/or directly with the stator.

Turning to FIG. 11, the end plate 600 is shown with the plurality of conductor bundles 404 extending therethrough. The conductor bundles 404 may each include a first portion 1102 on a first side of the end plate 600 and a second portion 1104 on a second side of the end plate 600. The second portion 1104 may be straight so as to fit within stator slots (e.g., stator slots 1412 of FIG. 14) formed in a stator (e.g., the stator 400 of FIGS. 4 and 5). The first portion 1102 (e.g., end windings) may be bent at an angle with respect to the second portion 1104 and adapted to fit within a manifold (e.g., the first manifold 300 of FIGS. 3-5). Though not shown in FIG. 11, the conductor bundles 404 may also include a third portion adapted to fit in a second manifold (e.g., the second manifold 500 of FIG. 5).

Further, as shown in FIG. 12, the second portions 1104 of the conductor bundles 404 may each be at least partially encased in an insulating tube 1202. The insulating tubes 1202 may be shrink wrap style tubes adapted to insulate the conductor bundles 404. There may be the same number of insulating tubes 1202 as conductor bundles 404 and end plate slots 604, such that one conductor bundle 404 may be wrapped in a single insulating tube 1202 and extend through a single end plate slot 604. In some examples, the insulating tubes 1202 may extend along an entire length of the second portions 1104. In other examples, the insulating tubes 1202 may extend less than the entire length of the second portions 1104. In other words, the insulating tubes 1202 may entirely or partially surround the portion of each of the plurality of conductor bundles positioned within stator slots (e.g., stator slots 1412 of FIG. 14).

For example, turning to FIGS. 13A and 13B, first portions 1102 of the conductor bundles 404 are shown fully and partially, respectively, encased by the insulating tubes 1202. The insulating tubes may be constructed of an insulating material (e.g., with lower thermal conductivity than the conductor bundles 404). FIGS. 13A and 13B show a single bundle of the conductor bundles 404 surrounded by one of the insulating tubes 1202 for clarity, however it is understood that more (e.g., all) of the conductor bundles 404 may be wrapped in one of the insulating tubes 1202. Further, the insulating tubes 1202 may be shrink wrap style tubes that wrap and conform to the shape of the conductor bundles 404. For example, the insulating tubes 1202 may be cylindrical in shape in examples where the conductor bundles 404 are cylindrical. In another example, the insulating tubes 1202 may be rectangular or duct-like in shape in examples where the conductor bundles 404 are rectangular. Thus, the shape of the insulating tubes 1202 may depend on the geometry of the conductor bundles 404.

As shown in FIG. 13A, a length 1302 of the insulating tubes 1202 may be approximately the same as a length 1308 of the second portion 1104. In this way, the insulating tubes 1202 may extend entirely through a stator (e.g., the stator 400 as shown in FIG. 5). The insulating tubes 1202 may not cover the first portion 1102 or a third portion 1306, wherein the first portion 1102 and the third portion 1306 are external to the stator (e.g., in the first manifold 300 or second manifold 500 of FIG. 5). Alternatively, as shown in FIG. 13B, the length 1302 may be less than the length 1308. In this way, the insulating tubes 1202 may extend partially though the stator. Thus, the insulating tubes 1202 may cover at least some of the portion of the conductor bundles 404 within the stator.

The technical effect of the in-slot cooling system of the present disclosure is to cool conductors of an electric machine comprising a rotor and a stator wherein the conductors are positioned within stator slots of a stator. Due to fluidic coupling of a first manifold holding first ends of the conductors and a second manifold holding second ends of the conductors via the stator slots, coolant may flow through the stator slots. In this way, the conductors may have greater surface area with exposure to coolant fluid than other cooling systems wherein coolant fluid is not allowed into the stator slots. Thus, a temperature of the conductors may be further reduced, allowing for continuous high power output of the electric machine with reduced likelihood of overheating. Further, the in-slot cooling system may prevent fluid from entering an air gap between the stator and the rotor, thereby reducing drag losses on rotation of the rotor. For example, an air gap tube positioned axially between the first manifold and the second manifold may seal the air gap and the rotor from coolant fluid. Therefore, the in-slot cooling system disclosed herein may reduce a temperature of the conductors without reducing efficiency of the electric machine.

FIGS. 1-14 show example configurations with relative positioning of the various components. FIGS. 2-12 are shown approximately to scale. Unless otherwise noted, if shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The disclosure also provides support for an in-slot cooling system, comprising: a tube positioned in an air gap between a stator and a rotor, a first manifold that encloses a first portion of a plurality of conductor bundles at a first end of the stator and a second manifold at a second end of the stator, the first manifold and the second manifold being coupled to the tube, and an end plate positioned at one end of the stator and protruding into one or more of a plurality of stator slots extending through the stator. In a first example of the system, the system further comprises: insulating tubes that entirely or partially surround a second portion of each of the plurality of conductor bundles positioned within the plurality of stator slots. In a second example of the system, optionally including the first example, the tube is longer than the stator and in face sharing contact with an inner surface of the first manifold and an inner surface of the second manifold. In a third example of the system, optionally including one or both of the first and second examples, end plate slots of the end plate are shaped according to the plurality of stator slots and one or more of the end plate slots protrudes into corresponding stator slots. In a fourth example of the system, optionally including one or more or each of the first through third examples, the tube is positioned closer to the stator than the rotor. In a fifth example of the system, optionally including one or more or each of the first through fourth examples, the tube is sealably coupled to the first manifold and the second manifold such that fluid does not flow through interfaces therebetween towards the rotor. In a sixth example of the system, optionally including one or more or each of the first through fifth examples, the end plate comprises one or more protrusions adapted to restrict movement of the plurality of conductor bundles and allow flow of coolant fluid therearound.

The disclosure also provides support for an in-slot cooling system, comprising: a first manifold positioned at a first end of a stator and a second manifold positioned at a second end of the stator, the first manifold and the second manifold fluidically coupled via stator slots extending through the stator, an air gap tube circumferentially surrounded by the stator and sealably coupled to the first manifold and the second manifold, insulating tubes surrounding a plurality of conductor bundles extending through the stator slots from within the first manifold to within the second manifold, and a first end plate comprising a protrusion extending axially into a corresponding stator slot. In a first example of the system, the plurality of conductor bundles is fixed in place by spacers of the protrusion. In a second example of the system, optionally including the first example, the protrusion comprises a combination of rounded sections and rectangular sections adapted to allow coolant fluid to flow around the plurality of conductor bundles extending through the protrusion. In a third example of the system, optionally including one or both of the first and second examples, the system further comprises: a second end plate positioned opposite the first end plate across the stator, wherein the protrusion and a second protrusion of the second end plate extend axially towards each other into the stator slots. In a fourth example of the system, optionally including one or more or each of the first through third examples, the first end plate is bonded to an end of the air gap tube and in face sharing contact with the stator. In a fifth example of the system, optionally including one or more or each of the first through fourth examples, a first inner dimeter of the first manifold, a second inner diameter of the air gap tube, and a third inner dimeter of the second manifold are approximately the same such that a first inner surface of the air gap tube is flush with a second inner surface of the second manifold and a third inner surface of the first manifold. In a sixth example of the system, optionally including one or more or each of the first through fifth examples, the insulating tubes partially or entirely surround a region of the plurality of conductor bundles positioned within the stator slots. In a seventh example of the system, optionally including one or more or each of the first through sixth examples, the plurality of conductor bundles further extends through the first end plate.

The disclosure also provides support for an electric machine, comprising: a rotor positioned within a stator, and an in-slot cooling system adapted to cool a plurality of conductor bundles extending through stator slots in the stator, wherein the in-slot cooling system comprises: a tube positioned between the rotor and stator, a first manifold on a first end of the stator and a second manifold on a second end of the stator, wherein the tube, the first manifold and the second manifold seal fluid outside of an air gap between the rotor and the tube, an end plate comprising one or more protrusions extending into the stator slots, and a plurality of insulating tubes at least partially surrounding each of the plurality of conductor bundles. In a first example of the system, the end plate is in face sharing contact with the stator and bonded to the tube such that the end plate circumferentially surrounds an end of the tube. In a second example of the system, optionally including the first example, the first manifold and the second manifold are fluidically coupled via the stator slots and the one or more protrusions extending into the stator slots. In a third example of the system, optionally including one or both of the first and second examples, the rotor, the stator, and the tube are coaxial and sized such that the tube is closer to the stator than the rotor. In a fourth example of the system, optionally including one or more or each of the first through third examples, the plurality of insulating tubes are shrink wrap style tubes with one insulating tube wrapped around each of the plurality of conductor bundles.

In another representation, a hybrid vehicle comprises: an engine and an electric machine comprising a rotor positioned within a stator and an in-slot cooling system adapted to cool a plurality of conductor bundles extending through stator slots in the stator, wherein the in-slot cooling system comprises: a tube positioned in an air gap between the rotor and stator; a first manifold on a first end of the stator and a second manifold on a second end of the stator, wherein the tube, the first manifold and the second manifold seal fluid outside of the air gap; an end plate comprising one or more protrusions extending into the stator slots; and a plurality of insulating tubes at least partially surrounding each of the plurality of conductor bundles.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations, and/or functions may be repeatedly performed depending on the particular strategy being used. Further, the described actions, operations, and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An in-slot cooling system, comprising:
a tube positioned in an air gap between a stator and a rotor;
a first manifold that encloses a first portion of a plurality of conductor bundles at a first end of the stator and a second manifold at a second end of the stator, the first manifold and the second manifold being coupled to the tube; and
an end plate positioned at one end of the stator and protruding into one or more of a plurality of stator slots extending through the stator.

2. The in-slot cooling system of claim 1, further comprising insulating tubes that entirely or partially surround a second portion of each of the plurality of conductor bundles positioned within the plurality of stator slots.

3. The in-slot cooling system of claim 1, wherein the tube is longer than the stator and in face sharing contact with an inner surface of the first manifold and an inner surface of the second manifold.

4. The in-slot cooling system of claim 1, wherein end plate slots of the end plate are shaped according to the plurality of stator slots and one or more of the end plate slots protrudes into corresponding stator slots.

5. The in-slot cooling system of claim 1, wherein the tube is positioned closer to the stator than the rotor.

6. The in-slot cooling system of claim 1, wherein the tube is sealably coupled to the first manifold and the second manifold such that fluid does not flow through interfaces therebetween towards the rotor.

7. The in-slot cooling system of claim 1, wherein the end plate comprises one or more protrusions adapted to restrict movement of the plurality of conductor bundles and allow flow of coolant fluid therearound.

8. An in-slot cooling system, comprising:
a first manifold positioned at a first end of a stator and a second manifold positioned at a second end of the stator, the first manifold and the second manifold fluidically coupled via stator slots extending through the stator;
an air gap tube circumferentially surrounded by the stator and sealably coupled to the first manifold and the second manifold;
insulating tubes surrounding a plurality of conductor bundles extending through the stator slots from within the first manifold to within the second manifold; and
a first end plate comprising a protrusion extending axially into a corresponding stator slot.

9. The in-slot cooling system of claim 8, wherein the plurality of conductor bundles is fixed in place by spacers of the protrusion.

10. The in-slot cooling system of claim 8, wherein the protrusion comprises a combination of rounded sections and rectangular sections adapted to allow coolant fluid to flow around the plurality of conductor bundles extending through the protrusion.

11. The in-slot cooling system of claim 8, further comprising a second end plate positioned opposite the first end plate across the stator, wherein the protrusion and a second protrusion of the second end plate extend axially towards each other into the stator slots.

12. The in-slot cooling system of claim 8, wherein the first end plate is bonded to an end of the air gap tube and in face sharing contact with the stator.

13. The in-slot cooling system of claim 8, wherein a first inner dimeter of the first manifold, a second inner diameter of the air gap tube, and a third inner diameter of the second manifold are approximately the same such that a first inner surface of the air gap tube is flush with a second inner surface of the second manifold and a third inner surface of the first manifold.

14. The in-slot cooling system of claim 8, wherein the insulating tubes partially or entirely surround a region of the plurality of conductor bundles positioned within the stator slots.

15. The in-slot cooling system of claim 8, wherein the plurality of conductor bundles further extends through the first end plate.

16. An electric machine, comprising:
a rotor positioned within a stator; and
an in-slot cooling system adapted to cool a plurality of conductor bundles extending through stator slots in the stator, wherein the in-slot cooling system comprises:
a tube positioned between the rotor and stator;
a first manifold on a first end of the stator and a second manifold on a second end of the stator, wherein the tube, the first manifold and the second manifold seal fluid outside of an air gap between the rotor and the tube;
an end plate comprising one or more protrusions extending into the stator slots; and
a plurality of insulating tubes at least partially surrounding each of the plurality of conductor bundles.

17. The electric machine of claim 16, wherein the end plate is in face sharing contact with the stator and bonded to the tube such that the end plate circumferentially surrounds an end of the tube.

18. The electric machine of claim 16, wherein the first manifold and the second manifold are fluidically coupled via the stator slots and the one or more protrusions extending into the stator slots.

19. The electric machine of claim 16, wherein the rotor, the stator, and the tube are coaxial and sized such that the tube is closer to the stator than the rotor.

20. The electric machine of claim 16, wherein the plurality of insulating tubes are shrink wrap style tubes with one insulating tube wrapped around each of the plurality of conductor bundles.
